(19) United States
(12) Patent Application Publication
(10) Pub. No.: US 2009/0307152 A1
(43) Pub. Date: Dec. 10, 2009

(54) Cost Management System

(75) Inventors: Jatinder Gogna, Baldwin Place, NY (US); Gerald Goodbody, Castro Valley, CA (US); Rajesh Seshadri, Cortlandt Manor, NY (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/135,811

(22) Filed: Jun. 9, 2008

(51) Int. Cl. G06G 7/00

(52) U.S. Cl. 705/400

(57) ABSTRACT

A cost management system for an inventory item defines a set of one or more attributes or “valuation structures”, and at least one value for each of the attributes in the set or “valuation unit”. The system receives a transaction involving the inventory item. The system then determines the cost of the inventory item based on the attribute values for the valuation structure of the item. Therefore, the cost of the inventory item will vary based on the attribute values.

### FIELD OF THE INVENTION

One embodiment is directed generally to a computerized accounting system, and in particular to a cost management system.

### BACKGROUND INFORMATION

A supply chain or logistics network is the system of organizations, people, technology, activities, information, and resources involved in moving a product or service from supplier to customer. Supply chain activities transform natural resources, raw materials and components into a finished product that is delivered to the end customer.

Supply chain management is the process of planning, implementing and controlling the operations of the supply chain as efficiently as possible. Supply chain management spans all movement and storage of raw materials, work-in-process inventory, and finished goods from point-of-origin to point-of-consumption. Supply chain management is typically implemented by integrated computer systems that include modules for such functions as general ledger, inventory management, human resources, customer relationship management, etc.

Inventory management for a supply chain is typically concerned with the quantity and location of inventory including raw materials, work-in-process, and finished goods. Cost management provides a way to track costs in production as well as in finished goods, and provides a link to accounting systems so that the financial aspects of goods can be properly calculated.

### SUMMARY OF THE INVENTION

One embodiment is a cost management system. The system, for an inventory item, defines a set of one or more attributes or “valuation structures”, and at least one value for each of the attributes in the set or “valuation unit”. The system receives a transaction involving the inventory item. The system then determines the cost of the inventory item based on the attribute values for the valuation structure of the item. Therefore, the cost of the inventory item will vary based on the attribute values.

### BRIEF DESCRIPTION OF THE DRAWINGS

FIG. 1 is a block diagram of a system that can implement an embodiment of the present invention.

FIG. 2 is a block diagram that illustrates how inventory and cost management module may generate an input structure for an organization to track item costs in accordance with one embodiment.

FIG. 3 is a block diagram of a cost profile in accordance with one embodiment.

FIG. 4 is a user interface in accordance with one embodiment that allows a user to define a valuation structure.

FIG. 5 is a user interface in accordance with one embodiment that allows a user to enter attribute values for each valuation unit that was defined in FIG. 4.

FIG. 6 is a flow diagram of the setup and processing for the cost management system in accordance with one embodiment.

FIG. 7 is a flow diagram of the setup and processing for an cost management system in accordance with another embodiment.

FIG. 8 is a user interface in accordance with one embodiment that illustrates the cost for an item.

### DETAILED DESCRIPTION

One embodiment is a cost management system that allows the cost of inventory items to be tracked with varying levels of granularity. This allows costs for the items to be more closely tracked to specific attributes.

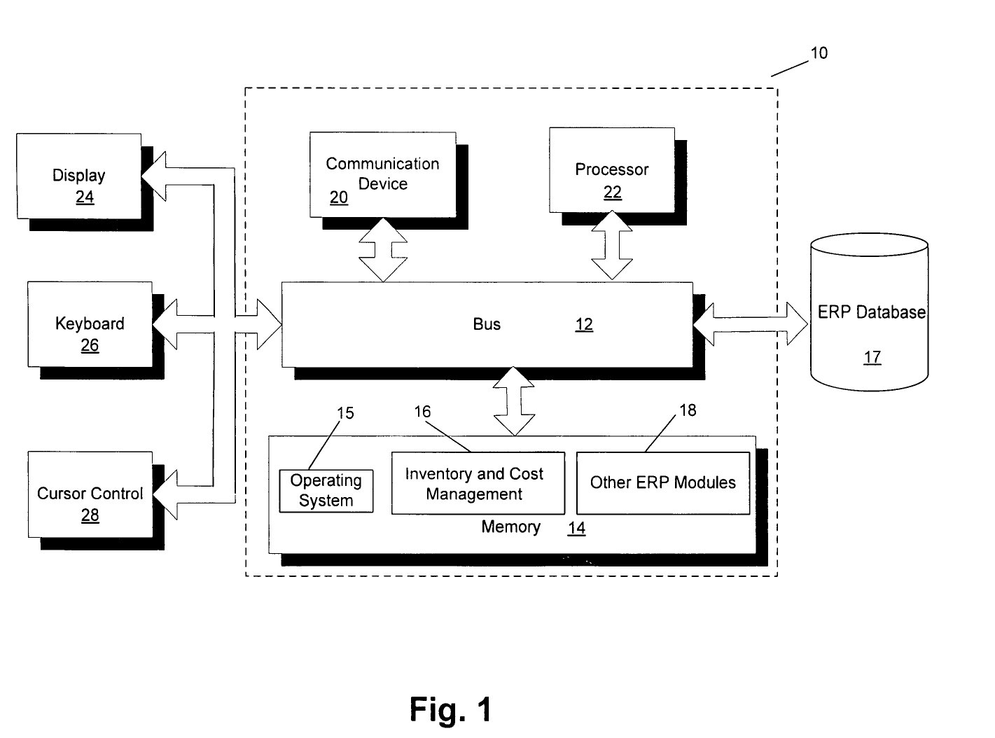

FIG. 1 is a block diagram of a system 10 that can implement an embodiment of the present invention. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include inventory and cost management module 16 that performs cost management as disclosed in more detail below. The modules further include other enterprise resource planning (“ERP”) modules 18 of an ERP system. An ERP system is a computer system that integrates several data sources and processes of an organization into a unified system. A typical ERP system will use multiple components of computer software and hardware to achieve the integration. A unified ERP database 17, coupled to bus 12, is used to store data for the various system modules. In one embodiment, ERP modules 18 are part of the “Oracle E-Business Suite Release 12” ERP system from Oracle Corp. In other embodiments, inventory and cost management 16 may be a stand-alone system and not integrated with an ERP system, or may be part of any other integrated system.

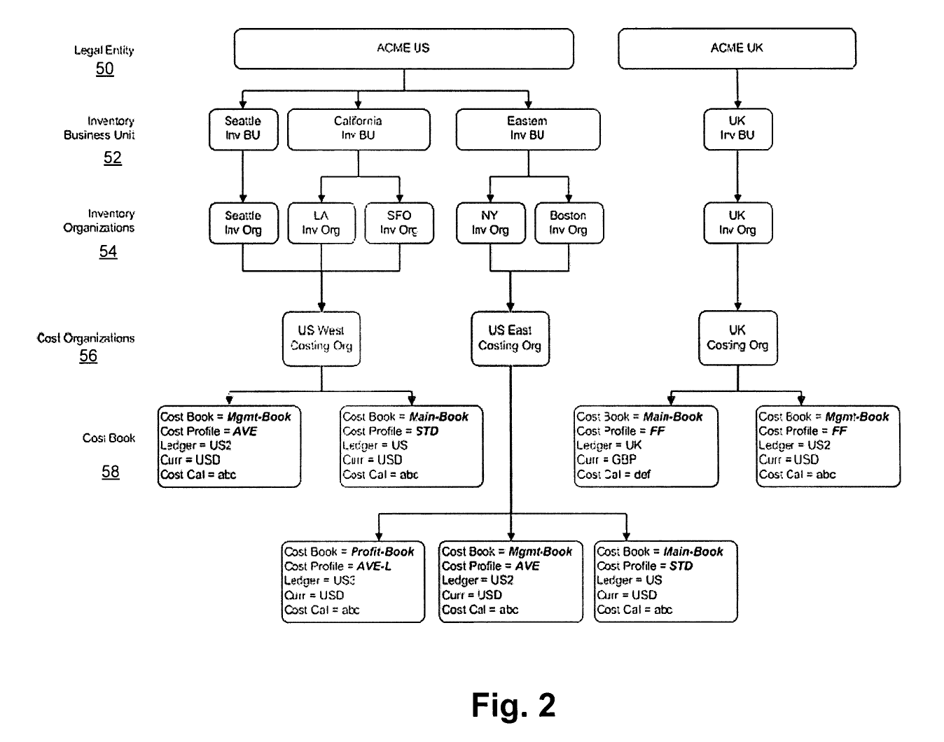

In one embodiment, inventory and cost management module 16 tracks the cost of each item or good in the inventory of an organization. An item or good can be anything that is used in a manufacturing process, such as raw materials and components. FIG. 2 is a block diagram that illustrates how inventory and cost management module 16 may generate an input structure for an organization to track item costs in accordance with one embodiment. An enterprise may be broken down into a one or more legal entities 50. Each legal entity can be divided into inventory business units 52. Each inventory business unit 52 may be a general location where inventory facilities are located. Inventory business units 52 can be linked to inventory organizations 54, which are the actual physical locations where inventory is stored.

Inventory organizations 54 can be linked to cost organizations 56. A cost organization 56 in one embodiment is a grouping of inventory organizations 54 and can be used to indicate the financial ownership of the items and establish common costing policies and responsibilities. Inventory organizations 54 linked to a cost organizations 56 can be from any business unit 52 as long as they belong to the same legal entity 50 in one embodiment. Cost organizations 56 also allow a user to share the item cost in multiple inventory organizations within a legal entity, regardless of their business units.

Cost organizations 56 are linked to cost books 58. A cost book 58 in one embodiment includes all of the costing and accounting data derived from the supply chain transactions and product management setups under a specified set of parameters and rules including the cost methods to use for an item or item category. A user can establish any number of cost books as necessary to obtain as many alternate representations of costing and accounting data.

In one embodiment, multiple cost books 58 may be assigned to a cost organization 56. However, a single primary cost book 58 should be assigned to a cost organization 56. A cost book assignment is treated as a primary book if the ledger assigned to it is the primary ledger of the legal entity to which the cost organization is linked to. Attributes assigned to a cost book include the cost book name, cost profile, ledger (optional for secondary book), ledger currency and ledger calendar.

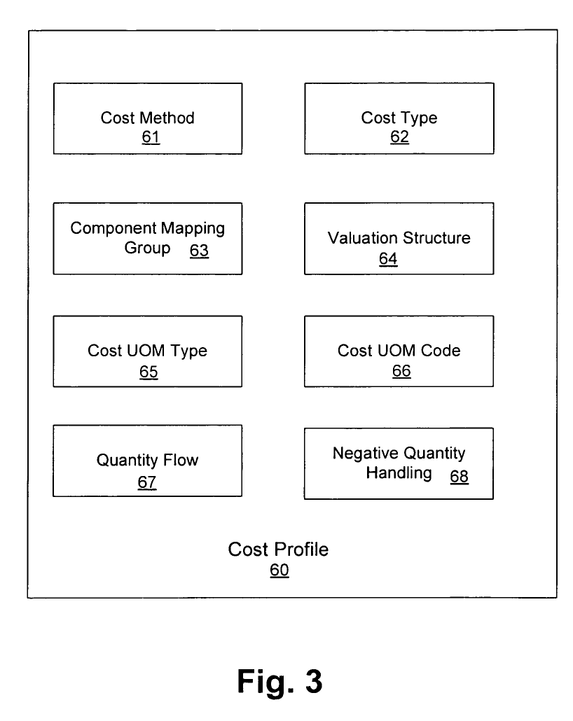

The cost profile is used to define the costing and accounting preferences/policies. FIG. 3 is a block diagram of a cost profile 60 in accordance with one embodiment. Cost profile 60 in one embodiment includes the following variables 61-68: cost method 61 or inventory valuation method (e.g., standard/periodic, standard/perpetual, perpetual average, last in, first out (“LIFO”), first in, first out (“FIFO”)); cost type 62, which indicates the valuation cost type if the cost method is standard; component mapping group 63, which indicates the mapping of the cost component to the cost element; valuation structure 64, which indicates the granularity of the cost; cost Unit of Measure (“UOM”) type 65 (e.g., Primary, Secondary, Other); cost UOM code 66 (for type “Other”); quantity flow 67; and negative quantity handling 68.

In one embodiment, valuation structure 64 is used to specify the granularity at which the cost of the item is maintained by defining a set of attributes for the item. In prior art inventory and cost management systems, each item is associated with only a single cost, even though the actual cost of an item may vary based on many factors. For example, in some industries the cost of an item varies by material grades. As the grade of the item changes, so do the value and the cost of the item. So, for example, in the dairy industry, a cheese may be evaluated as Grade A, Grade B, or Grade C, with the cost differing for each grade. In prior art cost management systems, three different items would need to be defined to account for the varying costs. Further, in some companies the inventory organizations are physically located together and use the same set of items, and the cost of the item may need to be maintained for a group of Inventory organizations. Further, in some industries, every lot of an item may need to be assigned a different cost.

In order to accommodate these needs, for each valuation structure 64 one or more “valuation units” are defined which identify the values of the control attributes for that valuation structure. Some examples of possible control attributes for a valuation unit include: inventory organization; subinventory; stock locator; material grade; lot; and serial no. The valuation units may be automatically or manually generated.

As an example, a valuation structure may be “Grade VU”=Inventory Organization/Material Grade. This valuation structure indicates that the cost of the Items will be maintained by Material Grade within an inventory organization. The following valuation units are examples of three valuation units that can be associated with valuation structure Grade VU:

### (1) Valuation Unit: ‘Top Grade’; Inventory Organization: NY

### Material Grades: Grade A, Grade B

### (2) Valuation Unit: ‘Medium Grade’; Inventory Organization: NY

### Material Grades: Grade C

### (3) Valuation Unit: ‘Spoiled’; Inventory Organization: NY

### Material Grades: Grade D.

Based on the three above valuation units, Grade A and Grade B indicates Top Grade and an item will have a single cost for inventory with these 2 grades. An item will have a different cost for Grade C, which indicates medium grade. Similarly, the item will have a different cost for Grade D. Therefore, multiple costs will be assigned to a single item depending on the grade of the item.

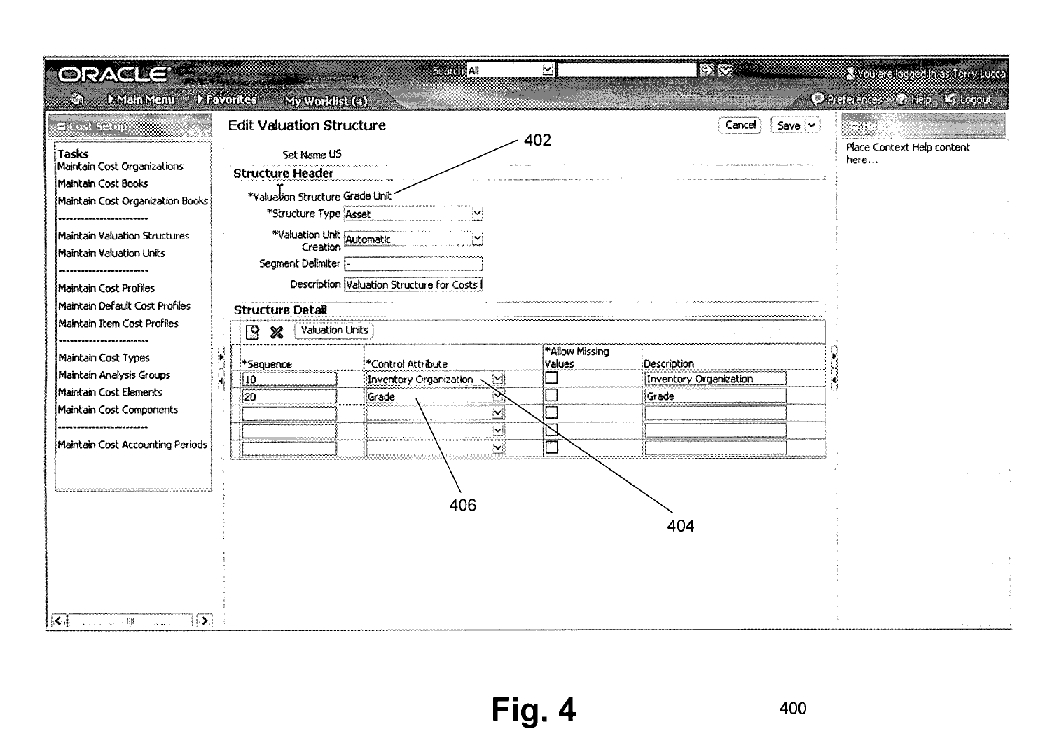

FIG. 4 is a user interface (“UI”) 400 in accordance with one embodiment that allows a user to define a valuation structure. In the example of FIG. 4, the valuation structure is called “Grade Unit” at 402. The valuation structure is further defined below as an inventory organization 404 and a grade 406. Therefore, the valuation structure of FIG. 4 allows the grade and inventory organization to be defined.

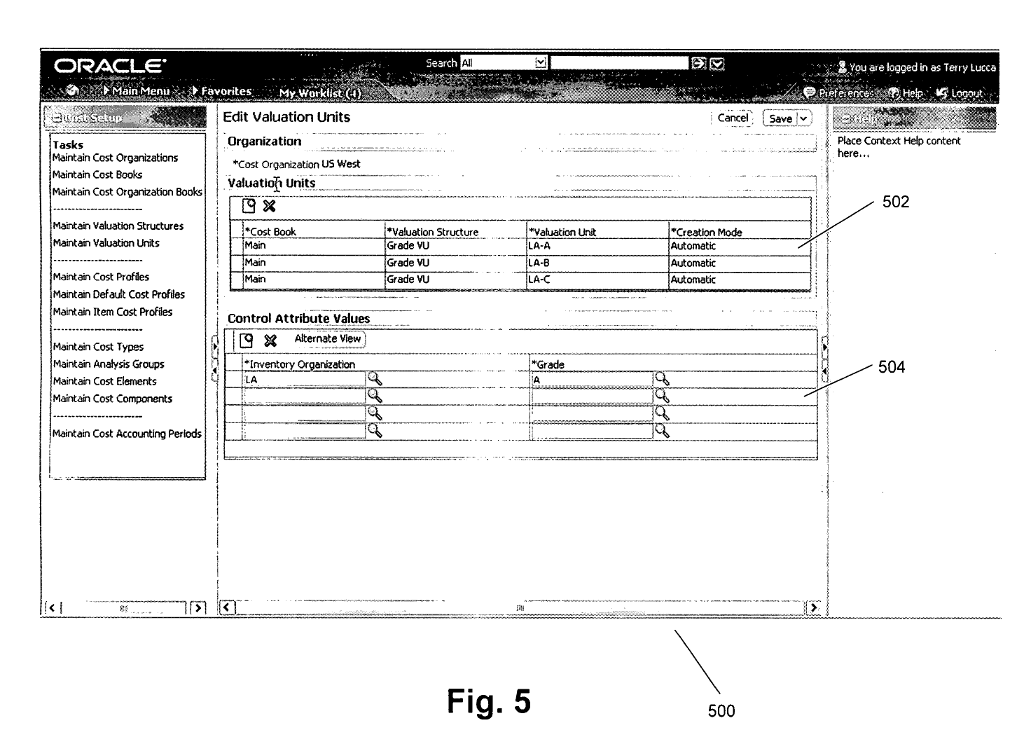

FIG. 5 is a user interface (“UI”) 500 in accordance with one embodiment that allows a user to define valuation units by entering attribute values for each valuation structure that was defined in FIG. 4. In the example of FIG. 5, table 502 includes three valuation units defined for Grades A-C in the LA inventory organization. Table 504 allows attribute values to be controlled for each of the valuation units shown in table 502. In the example of FIG. 5, LA-A has been selected.

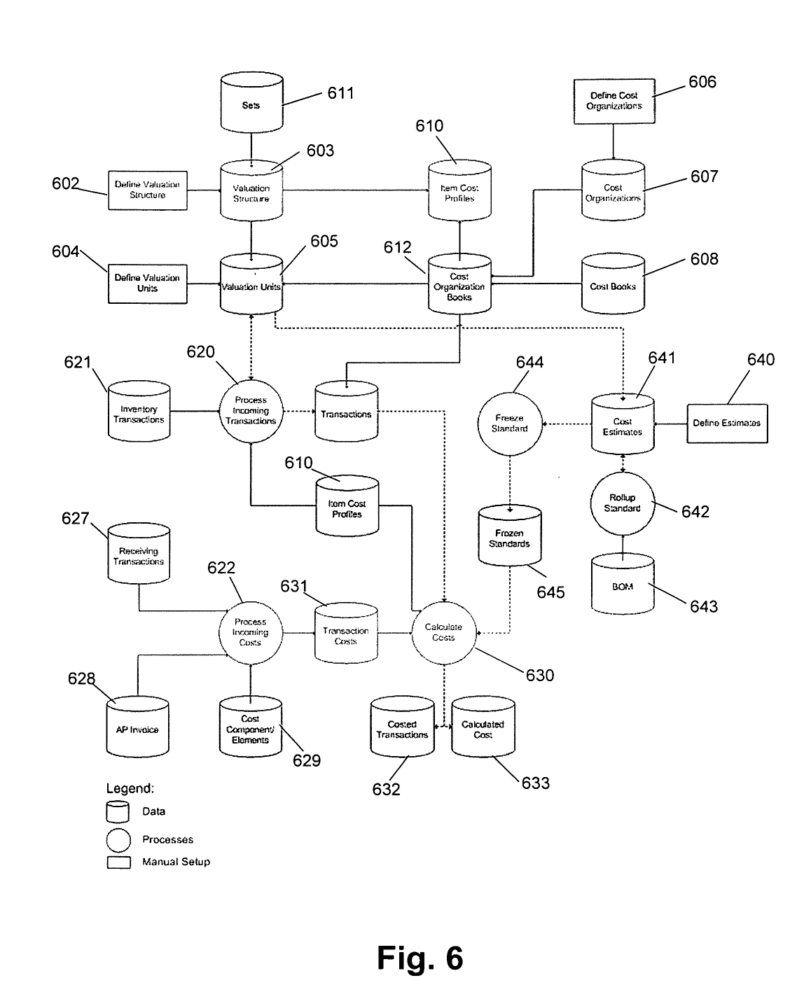

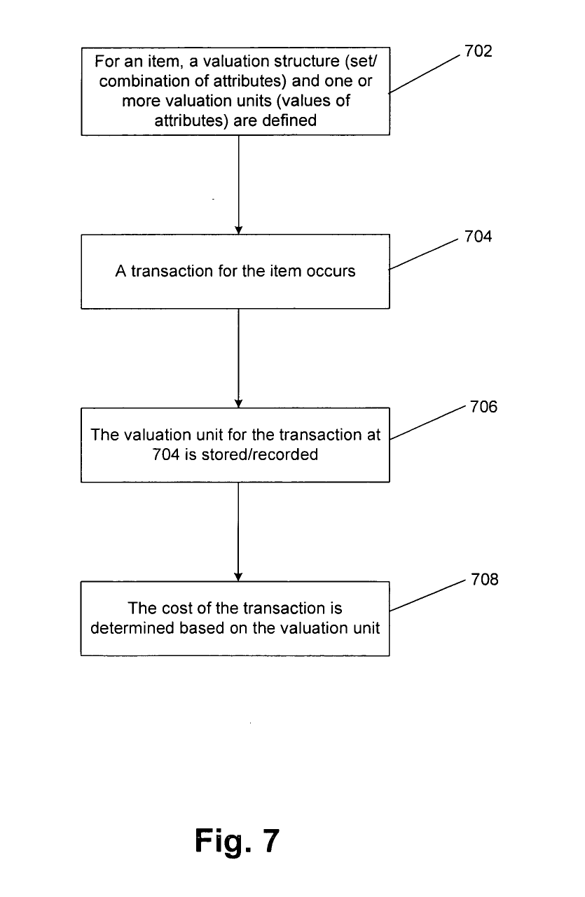

FIG. 6 is a flow diagram of the setup and processing for the cost management system in accordance with one embodiment. In one embodiment, the functionality of the flow diagram of FIG. 6, and FIG. 7 below, is implemented by software stored in memory or other computer readable or tangible medium, and executed by a processor. In other embodiments, the functionality can be performed by hardware, or any combination of hardware and software.

Valuation structures are defined at 602 and stored at 603. Valuation units are defined at 604 and stored at 605. “Sets” are stored at 611. A set is a user defined set of cost organizations for which the user would like to define valuation structure. This provides the user with the capability to define a valuation structure for a single, all, or a set of cost organizations depending on business needs.

Cost organizations are defined at 606 and stored at 607. Cost books are stored at 608. Cost organizations 607 and cost books 608 are combined and stored at 612 as cost organization books. Cost profiles 610 are defined/generated for cost organization books 612 and reference valuation structures 603 for cost calculations.

Inventory transactions from 621 are processed at 620. Transaction processing 620 uses the cost profiles 610 and valuation units 605 to determine costs based on item attributes. Incoming transactions' costs are processed at 622 from receiving transactions 627 and account payable invoices 628. Cost component/elements 629 map these transaction costs to the cost elements. The transaction costs are stored at 631.

Cost estimates are defined at 640 and stored at 641. The cost estimates are for the “Standard Cost Methods”. In this type of cost method, the item cost is not computed from the transaction cost, but is pre-defined based upon estimates for the raw materials. Cost rollup 642 computes the costs or products based on raw material costs and Bills of Material 643 (“BOM”) for products. Freeze standards 644 and 645 is a process by which the calculated standard costs are finalized for accounting purposes. Any deviation of actual costs from standard costs are recorded as variances during accounting.

At 630, costs are calculated. As shown, costs are calculated using as input transaction costs 631 and cost profiles 610. Therefore, the valuation units are taken into account when determining the costs of the transactions. The calculated costs are stored at 633 and the costed transactions are stored at 632. Costed transactions 632 and calculated costs 633 are available to the General Ledger module and other modules of the ERP system in one embodiment to be used for further calculations.

FIG. 7 is a flow diagram of the setup and processing for a cost management system in accordance with another embodiment. At 702, for an item, a valuation structure or set/combination of attributes of the item is defined (e.g., grades, inventory locations, etc.), and one or more valuation units (e.g., the values of the attributes) are defined. In one embodiment, a valuation unit is a specific value of the valuation structure (e.g., the specific grades for the item, the actual inventory locations where the item is stored, etc.).

At 704, a transaction for the item occurs.

At 706, the valuation unit for the transaction at 704 is stored/recorded or “stamped”.

At 708, the cost of the transaction is determined based on the valuation unit. In one embodiment, each valuation unit will be associated with a different cost. For example, Grade A may cost $100, Grade B may cost $80, etc. Therefore, the cost of the item will vary depending on the corresponding valuation unit.

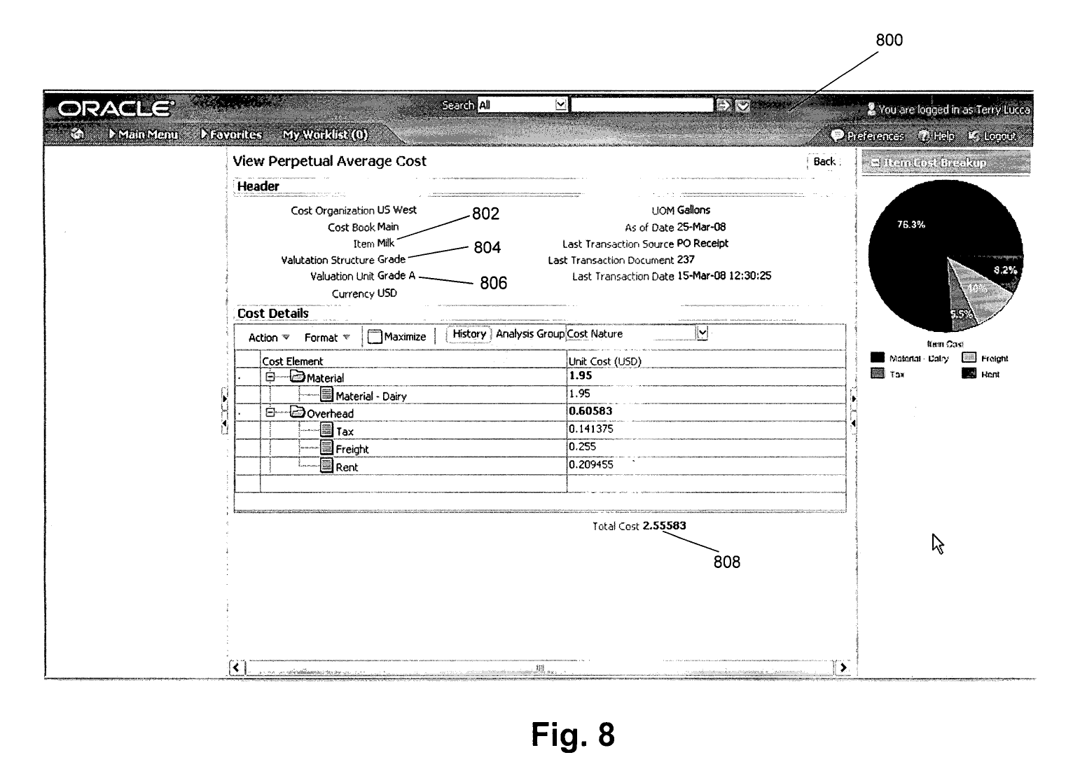

FIG. 8 is a user interface 800 in accordance with one embodiment that illustrates the cost for an item. In the example shown in FIG. 8, the item is “milk” at 802 and it has a valuation structure of “Grade” at 804 and a valuation unit of “Grade A” at 806. The total cost of the item is $2.55583 at 808, which includes material costs and overhead cost. If a different valuation unit for milk is displayed on user interface 800, for example, “Grade B”, the total cost would likely be different.

As disclosed, the cost management system in one embodiment allows multiple attributes to be defined for an inventory item, and different costs to be defined for each attribute. Therefore, costs for an item can be maintained at a desired granularity within the cost management system.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable media having instructions stored thereon that, when executed by a processor, causes the processor to manage costs of an inventory item, the instructions comprising:
logic for defining a set of one or more attributes and at least one value for each of the attributes of the set for the item;
logic for receiving a transaction for the item; and
logic for determining a cost of the transaction based on the at least one value of the attributes that corresponds to the item.

2. The computer readable media of claim 1, wherein the cost will vary based on the attribute value.

3. The computer readable media of claim 1, wherein the attributes comprise at least one of: inventory organization, subinventory, stock locator, material grade, lot and serial number.

4. The computer readable media of claim 1, wherein the set of attributes and the at least one value for each of the attributes in the set are stored in a database of an enterprise resource planning system.

5. The computer readable media of claim 1, wherein the set of attributes is a valuation structure of a cost profile.

6. The computer readable media of claim 5, wherein the cost profile is part of a cost book of a cost organization.

7. The computer readable media of claim 1, wherein the item is associated with multiple costs that are based on the attribute values.

8. The computer readable media of claim 1, wherein the at least one value is a valuation unit.

9. A method executing a cost management system, the method comprising:
defining a set of one or more attributes and at least one value for each of the attributes in the set for an item;
receiving a transaction for the item; and
determining a cost of the transaction based on the at least one value of the attributes that corresponds to the item.

10. The method of claim 9, wherein the cost will vary based on the attribute value.

11. The method of claim 9, wherein the attributes comprise at least one of: inventory organization, subinventory, stock locator, material grade, lot and serial number.

12. A cost management system comprising:
a processor;
memory coupled to the processor and storing a cost management module and additional integrated enterprise modules; and
a database coupled to the processor;
wherein the cost management module defines for an inventory item a set of one or more attributes and at least one value for each of the attributes.

13. The cost management system of claim 12, wherein the additional integrated enterprise modules comprise an enterprise resource planning system that stores data on the database.

14. The cost management system of claim 13, wherein the enterprise resource planning system receives a transaction for the item, and the cost management module determines a cost of the transaction based on the at least one value of the attribute that corresponds to the item.

15. The cost management system of claim 14, wherein the cost is received by a general ledger module of the enterprise resource planning system.

16. A system for managing costs of an enterprise, the system comprising:
means for defining a set of one or more attributes and at least one value for each of the attributes in the set for an inventory item;
means for receiving a transaction for the item; and
means for determining a cost of the transaction based on the at least one value of the attributes that corresponds to the item.
